(19) United States
(12) Patent Application Publication
(10) Pub. No.: US 2025/0236553 A1
(43) Pub. Date: Jul. 24, 2025

(54) METHOD OF IMPROVING DIELECTRIC PERFORMANCE OF ALUMINO-BOROSILICATE GLASS

(71) Applicant: CORNING INCORPORATED, CORNING, NY (US)

(72) Inventors: Ling Cai, Painted Post, NY (US); Lisa Ann Lamberson, Painted Post, NY (US)

(21) Appl. No.: 18/848,228

(22) PCT Filed: Mar. 22, 2023
(86) PCT No.: PCT/US2023/015892

§ 371 Date: Sep. 18, 2024

Related U.S. Application Data
(60) Provisional application No. 63/324,835, filed on Mar. 29, 2022.

(51) Int. Cl. C03C 4/16; C03B 32/00; C03C 3/091; C03C 3/093; C03C 3/11

(52) U.S. Cl. CPC C03C 4/16; C03B 32/00; C03C 3/091; C03C 3/093; C03C 3/11; C03C 2204/00

(57) ABSTRACT

A method of improving dielectric performance of alumino-borosilicate glass includes heating the glass to a heated temperature of at least 400° C. and less than 1200° C. keeping the glass at the heated temperature for at least 30 minutes, followed by cooling the glass to a cooled temperature of 40° C. over at least 2 hours. In terms of constituents, the glass includes SiO₂, Al₂O₃, B₂O₃, MgO, and CaO. After the cooling. the glass has a dielectric loss tangent no greater than 0.0020.

### CROSS-REFERENCE TO RELATED APPLICATION

This application claims the benefit of priority under 35 U.S.C. § 119 of U.S. Provisional Application Ser. No. 63/324,835 filed on Mar. 29, 2022, the content of which is relied upon and incorporated herein by reference in its entirety.

### BACKGROUND

Aspects of the present disclosure generally relate to glass with low loss tangents and corresponding dielectric constants, and a process to lower loss tangents of the glass.

Glass may be used as a low-loss substrate for electronics, such as antennas, printed circuit boards, etc. Lower loss tangents may improve performance of the glass in such applications. Applicants previously invented low-loss glasses useful as substrates for antennas, as provided in U.S. Pat. No. 11,117,828, which is incorporated by reference herein in its entirety. More specifically, Applicants discovered that, for such alumino-borosilicate glasses, a combination of magnesium oxide and another alkaline earth metal oxide, such as calcium oxide, produce molten glass with a viscosity suitable for fusion forming and still provide a low dielectric loss tangent and corresponding dielectric constant.

While such fusion formable glasses as disclosed are useful, a need still exists for such glasses with further improved dielectric properties.

### SUMMARY

Since the discoveries disclosed in the Background, Applicants further explored this composition space and discovered a process to further improve dielectric properties of such glasses, including an ability to lower the dielectric loss tangent of such glass by about 30%!

According to an aspect of the present disclosure, the process includes an extended heat treatment followed by a gradual cooling of alumino-borosilicate glasses, after forming the glasses into sheets.

One step may include heating the glass and holding the glasses for a minimum time period, such as greater than (“>”) 30 minutes, such as >60 minutes, >90 minutes, at least (“≥”) 2 hours at or above a heated temperature of a lower bound >300° C., such as >400° C., ≥500° C., ≥600° C., ≥700° C., but an upper bound of less than a temperature corresponding to a softening point of the glasses, such as less than (“<”) 1000° C., such as <900° C., no more than (“≤”) 800° C., ≤750° C. Applicants believe that holding the glasses at such heated temperatures even longer than such times may generally further improve dielectric properties of the glasses, but may yield diminishing returns.

Another step may include cooling the glasses from the heated temperature down to a cooled temperature of about 40° C. According to an aspect, the glass is gradually cooled such that the temperature is reduced from the heated temperature to the cooled temperature over at least 2 hours, such as over at least 4 hours, at least 8 hours, at least 12 hours. During this step, the rate of cooling may occur faster while the glass is near (e.g., within 100° C. thereof) the heated temperature than while the glass is near the cooled temperature. Once the glasses reach the cooled temperature, the glasses may be further cooled, such as to well below the cooled temperature.

According to an Aspect (1) of the present disclosure, a method of improving dielectric performance of alumino-borosilicate glass includes a step of heating the glass to a heated temperature of at least 400° C., where the heated temperature is less than 1200° C. In terms of as-analyzed constituents, the glass includes at least 60 mol % to 75 mol % SiO₂, at least 2 mol % to 9 mol % Al₂O₃, at least 15 mol % to 25 mol % B₂O₃, at least 1 mol % to 6 mol % MgO, and at least 1 mol % to 5 mol % CaO. The method includes a step of keeping the glass at the heated temperature for at least 30 minutes. The method further includes another step of cooling the glass from the heated temperature to a cooled temperature of 40° C., where the cooling occurs over a long time period, such as at least 30 minutes, at least 1 hour, at least 2 hours. Aspect (1) may further include an Aspect (2) that, after the cooling, the glass has a dielectric loss tangent (Df) no greater than 0.0020. Aspect (2) may further include an Aspect (3) that the heated temperature is at least 600° C. Aspect (3) may further include an Aspect (4) that the cooling occurs over at least 4 hours. Aspect (1) may further include an Aspect (5) that, prior to the heating, the glass has been formed as a sheet.

According to an Aspect (6) of the present disclosure, a method of improving

dielectric performance of alumino-borosilicate glass includes a step of forming the glass into a sheet In terms of as-analyzed constituents, the glass includes at least 60 mol % to 75 mol % SiO₂, at least 2 mol % to 9 mol % Al₂O₃, at least 15 mol % to 25 mol % B₂O₃, at least 1 mol % to 6 mol % MgO, and at least 1 mol % to 5 mol % CaO. The method includes a step of keeping the sheet at the heated temperature for at least 30 minutes. The method further includes another step of cooling the sheet from a heated temperature to a cooled temperature of 40° C., over a long time period, such as at least 30 minutes, at least 1 hour, at least 2 hours. The heated temperature is at least 400° C. Aspect (6) may further include an Aspect (7), a step including bonding electronics to the sheet. Aspect (7) may further include an Aspect (8) that the bonding is after the cooling. Aspect (6) may further include an Aspect (9), that, after the cooling, the sheet has a Df no greater than 0.0020. Aspect (6) may further include an Aspect (10), that the heated temperature is at least 600° C. Aspect (10) may further include an Aspect (11), that the heated temperature is less than 1000° C. Aspect (6) may further include an Aspect (12), that the cooling occurs over at least 4 hours.

According to an Aspect (13) of the present disclosure, a method of improving dielectric performance of alumino-borosilicate glass includes a step of forming a glass into a sheet. In terms of as-analyzed constituents, the glass includes at least 60 mol % to 75 mol % SiO₂, at least 2 mol % to 9 mol % Al₂O₃, at least 15 mol % to 25 mol % B₂O₃, at least 1 mol % to 6 mol % MgO, and at least 1 mol % to 5 mol % CaO. The method includes another step of heating the sheet to a heated temperature of at least 400° C., where the heated temperature is less than 1200° C. The method includes a step of keeping the glass at the heated temperature for at least 30 minutes. The method includes yet another step of cooling the sheet to a cooled temperature of 40° C. Aspect (13) may further include an Aspect (14), that the glass comprises less than 7.5 mol % Al₂O₃, greater than 16 mol % B₂O₃, less than 5.5 mol % MgO. Aspect (14) may further include an Aspect (15), that, after the cooling, the sheet has a Df no greater than 0.0020. Aspect (14) may further include an Aspect (16), that the heated temperature is at least 600° C. Aspect (14) may further include an Aspect (17), that the cooling occurs over at least 4 hours.

According to an Aspect (18) of the present disclosure, a method of improving dielectric performance of alumino-borosilicate glass includes a step of heating the glass to a heated temperature of at least 400° C., where the heated temperature is less than 1200° C. In terms of as-analyzed constituents, the glass includes SiO₂, Al₂O₃, B₂O₃, MgO; and CaO. The method includes another step of cooling the glass from the heated temperature to a cooled temperature of 40° C., over at least 2 hours. After the cooling, the glass has a Df no greater than 0.0020. Aspect (18) may further include an Aspect (19), that, prior to the heating, the glass has been formed as a sheet. Aspect (19) may further include an Aspect (20), where the method further includes a step of bonding electronics to the sheet after the cooling.

Additional features and advantages are set forth in the detailed description that follows, and in part will be readily apparent to those skilled in the art from the description or recognized by practicing the technology as described in the written description and claims hereof, as well as the appended drawings. It is to be understood that both the foregoing general description and the following detailed description are merely exemplary and are intended to provide an overview or framework to understand the nature and character of the claims.

### BRIEF DESCRIPTION OF THE FIGURES

The accompanying figures are included to provide a further understanding and are incorporated in and constitute a part of this specification. The drawings of the figures illustrate one or more aspects of the present disclosure, and together with the detailed description explain principles and operations of the various aspects. As such, the disclosure will become more fully understood from the following detailed description, taken in conjunction with the accompanying figures, in which:

FIG. 1 is a process flowchart according to an aspect of the present disclosure.

FIG. 2 is a perspective view of sheet of glass supporting circuitry according to an aspect of the present disclosure.

### DETAILED DESCRIPTION

Before turning to the following detailed description and figures, which illustrate aspects of the present disclosure in detail, it should be understood that the present inventive technology is not limited to the details or methodology set forth in the detailed description or illustrated in the figures. For example, as will be understood by those of ordinary skill in the art, features and attributes associated with an aspect shown in one of the figures or described in the text relating to an aspect may be applied to another aspect shown in another of the figures or described elsewhere in the text.

Unless otherwise specified, all compositions are expressed in terms of as-analyzed mole percentages (mol %), meaning mole percentages of constituents that produce the glass in an ideal batch, such as with negligible contamination and volatilization; or put another way, the as-analyzed mol % is measurement of constituents present in resulting glass, which may have been slightly altered from as-batched mol % during manufacturing, such as possibly to include additional silica from silica refractory, etc. Furthermore, as will be understood by those having ordinary skill in the art, various melt constituents (e.g., fluorine, alkali metals, boron, etc.) may be subject to different levels of volatilization (e.g., as a function of vapor pressure, melt time and/or melt temperature) during melting of the constituents. The term “about,” in relation to such constituents, is intended to encompass values within about 1 mol % to cover as-batched amounts. With the forgoing in mind, substantial compositional equivalence between final articles (e.g. sheets) and as-batched compositions is expected.

According to an aspect of the present disclosure, glasses may include SiO₂ in an amount from about 60% by mole of oxide (mol %) to about 75 mol %. The amount of SiO₂ may be in the range of about 60 mol % to about 73 mol %, about 60 mol % to about 70 mol %, about 65 mol % to about 73 mol %, about 65 mol % to about 70 mol %, or any amount of SiO₂ between these values.

The glasses may include Al₂O₃ in an amount from 2 mol % to about 10 mol %, such as about 3 mol % to about 9 mol %, about 3 mol % to about 8 mol %, about 5 mol % to about 10 mol %, about 5 mol % to about 9 mol %, about 7 mol % to about 9 mol %, or any amount of A1203 between these values.

The glasses may include B₂O₃ in an amount from about 10 mol % to about 28 mol %. The amount of B₂O₃ may be in the range of about 10 mol % to about 26 mol %, about 12 mol % to about 24 mol %, about 16 mol % to about 28 mol %, or any amount of B₂O₃ between these values.

The glasses may include one or more alkaline earth oxides (RO), where RO is CaO, MgO, BaO, and/or SrO. The one or more alkaline earth oxides may be present individually or in a combined amount of from greater than or equal to 0 mol % to about 12 mol %, from greater than or equal to 0 mol % to about 8 mol %, about 0.001 mol % to about 12 mol %, about 0.001 mol % to about 10 mol %, about 0.001 mol % to about 8 mol %, about 1 mol % to about 12 mol %, about 1 mol % to about 10 mol %, about 1 mol % to about 8 mol %, or any amount between these values. For example, the glass may include MgO and/or CaO, each present in the above amounts.

Further, the glass may include MgO and at least one additional RO constituent selected from CaO, BaO, and SrO, where a total amount of alkaline earth oxides (RO_{Total}), i.e. MgO and the at least one additional RO, may be from about 3 mol % to about 12 mol %. For example, RO_{Total} may be from about 3 mol % to about 10 mol %, about 3 mol % to about 8 mol %, about 4 mol % to about 12 mol %, about 4 mol % to about 10 mol %, about 4 mol % to about 8 mol %, about 5 mol % to about 10 mol %, or any amount between these values. A ratio of the amount of MgO to RO_{Total} (MgO: RO_{Total}) may be at least 0.3, at least 0.4, at least 0.5, at least 0.6, at least 0.7 or at least 0.8, and/or less than 1, such as less than 0.9, 0.8, 0.7, or any ratio between these values.

Further, the amount of MgO and the amount of additional RO may be selected as described above, and in concert with an amount of Al₂O₃ present in the glass such that a ratio of RO_{Total} to Al₂O₃ (RO_{Total}: Al₂O₃) is greater than 1. Providing a glass with a ratio RO_{Total}: Al₂O₃>1, may facilitate forming a manufacturable glass that can be drawn using glass forming processes, such as a fusion draw. Put another way, the glasses may also have properties suitable for manufacturing, and in particular suitable for forming processes such as slot-draw, overflow fusion drawing, and laminate fusion forming. The amounts of alkaline earth oxides, B₂O₃, and Al₂O₃ may be selected such that a ratio of RO_{Total}: (Al₂O₃+B₂O₃) in the glass is from about 0.2 to about 0.6.

The glasses of the present disclosure may include one or more fining agents, such as, by way of non-limiting example, SnO₂, Sb₂O₃, As₂O₃, and/or one or more halogen salts, including fluorine, chlorine, or bromine salts. When a fining agent is present in the glass, the fining agent may be present in a total amount less than about 1 mol %.

Glasses of the present disclosure may include at least one alkali metal oxide (R₂O), where R₂O is Li₂O, Na₂O, and/or K₂O. The one or more alkali metal oxides may be present individually or in a combined amount of from 0 mol % to about 6 mol %, such as from about 0.001 mol % to about 6 mol %, about 0.001 mol % to about 5 mol %, about 0.001 mol % to about 4 mol %, about 0.001 mol % to about 3 mol %, about 0.001 mol % to about 2 mol %. For example, LizO may be present in an amount of from 0 mol % to about 6 mol %.

Glasses of the present disclosure may have a density of from about 2.1 g/cm³ to about 2.4 g/cm³, as measured at about 25° C. (about room temperature), such as from about 2.2 g/cm³ to about 2.3 g/cm³.

As used herein Dk refers to the dielectric constant, such as relative to vacuum, and Df refers to the loss tangent, dissipation of electromagnetic energy by glass of this disclosure. Unless otherwise noted, the Df and Dk of glasses are measured at frequencies of 10 GHz (but may be measured at greater frequencies, such as 30 GHz) according to a split post dielectric resonator (SPDR) or an open-cavity resonator configuration according to techniques as understood by those with ordinary skill in the field of the disclosure. The particular method chosen may be selected based on the sample thickness and its lateral dimensions.

Glasses of the present disclosure may be characterized by a dielectric constant Dk of about 10 or less, as measured with signals at 10 GHz. In some implementations, the glass has a dielectric constant Dk of about 5 or less, such as about 4.7 or less, and/or at least about 3, such as at least about 4, as measured with signals at 10 GHz.

The glasses may be characterized by a loss tangent of about 0.003 or less, as measured with signals at 10 GHz and/or at 30 GHz. Glasses of the present disclosure may be characterized by a loss tangent of about 0.0025 or less, such as 0.0022 or less, 0.002 or less, 0.0018 or less and/or at least 0.0008, as measured with signals at 10 GHz and/or 30 GHz.

Beyond composition, Applicants discovered that process steps, after forming a glass, may lower dielectric properties of glasses and corresponding articles disclosed herein. For example, Applicants experimented with the following compositions (A to F) in terms of as-analyzed mol %, in Table 2.

TABLE 2

| oxide mol % | A | B | C | D | E | F |
|---|---|---|---|---|---|---|
| SiO₂ | 67.39 | 67.53 | 67.70 | 67.84 | 68.32 | 68.53 |
| Al₂O₃ | 10.99 | 10.80 | 9.20 | 9.10 | 8.52 | 8.51 |
| B₂O₃ | 9.94 | 9.93 | 11.11 | 11.21 | 11.99 | 11.85 |
| MgO | 2.30 | 2.66 | 5.14 | 5.14 | 5.05 | 5.02 |
| CaO | 8.76 | 8.50 | 6.49 | 6.38 | 5.82 | 5.79 |
| SrO | 0.53 | 0.48 | 0.17 | 0.17 | 0.17 | 0.17 |
| SnO₂ | 0.08 | 0.08 | 0.18 | 0.16 | 0.13 | 0.12 |

For each composition in Table 2, Applicants measured Dk and Df at 30 GHz of the as-formed glass. Then Applicants heated the glasses to 720° C., held the glasses at about that temperature (e.g., within 50° C. thereof) for 2 hours, and then slowly cooled the glasses (quench), at a gradual rate such as overnight, or over at least 8 hours, to a cooled temperature of about 40° C., such as room temperature or 25° C. Temperature during the cooling was decreasing linearly, or at a rate proportional to the difference in glass temperature to 25° C. Following this treatment, Applicants again measured Dk and Df at 30 GHz, and found substantial improvement, as listed in the following Table 3:

TABLE 3

| | Dk | Dk | Df | Df |
|---|---|---|---|---|
| | (as | (after | (as | (after |
| Sample | formed) | treatment) | formed) | treatment) |
| A | 5.02 | 5.14 | 0.0072 | 0.0060 |
| B | 5.02 | 5.09 | 0.0070 | 0.0059 |
| C | 4.82 | 4.92 | 0.0061 | 0.0048 |
| D | 4.77 | 4.88 | 0.0060 | 0.0048 |
| E | 4.70 | 4.82 | 0.0056 | 0.0045 |
| F | 4.68 | 4.79 | 0.0055 | 0.0043 |

In addition to the above experiments, Applicants also held the C composition of Table 1 at a temperature of 520° C. for two hours followed by quench, and achieved Dk of 4.90 and Df 0.0053, slightly less improvement than occurred with treatment at 720° C. for 2 hours followed by slowly cooling as shown in Table 2. Similarly, Applicants held composition D at 520° C. for two hours followed by quench and achieved Dk of 4.80 and Df of 0.0053, again slightly less improvement; but when held at 520° C. for 24 hours followed by quench, composition D achieved Dk 4.86 and Df of 0.0048, almost the same as with treatment at 720° C. for 2 hours followed by slowly cooling.

Furthermore, when composition D was held at 620° C. for 24 hours and quenched, the result was Dk of 4.92 and Df of 0.0047, slightly better than with treatment at 720° C. for 2 hours followed by slowly cooling. Applicants found composition F of Table 1 had similar performance to compositions C and D, where holding for 2 hours at 720° C. provided a good balance between time kept at the heated temperature to dielectric performance improvement, consistently raising Dk and lowering Df by about 0.0012. Holding the glasses at such heated temperatures longer than about 2 hours may generally further improve dielectric properties of the glasses, but may yield diminishing returns.

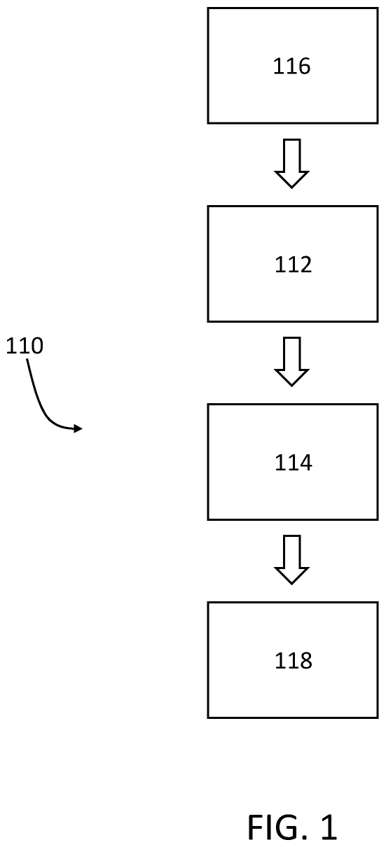

Referring to FIG. 1, according to an aspect of the present disclosure, a process 110 to improve dielectric properties of an alumino-borosilicate glass as disclosed herein includes an extended heat treatment followed by a gradual cooling of alumino-borosilicate glasses, after forming the glasses into sheets.

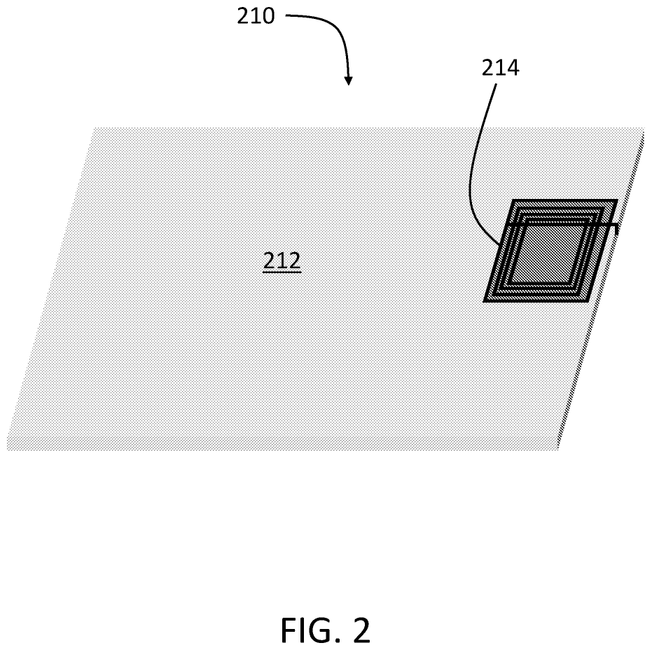

A step 112 may include holding the glasses for greater than (“>”) 30 minutes, such as >60 minutes, >90 minutes, at least (“≥”) 2 hours at or above a heated temperature of >300° C., such as >400° C., ≥500° C., ≥600° C., ≥700° C., but less than a temperature corresponding to a softening point of the glasses, such as less than (“<”) 1200° C., such as <1000° C., <900° C., no more than (“≤”) 800° C., ≤750° C. The heated temperature can be a range of temperatures and/or may have variation, and need not be held strictly constant during the step 112. For example, the actual temperature of the heated temperature may vary, but remain on average over a minimum time period (e.g., at least 30 minutes or any other such minimum time periods disclosed above, including >2hrs) within a range of a lower bound (e.g., >400° C. or any of the above lower bounds) to an upper bound (e.g., <1200° C. or any of the above upper bounds). The heating step may occur concurrently with forming 116 of the glass or may occur afterward, as a post-forming step. According to an aspect, prior to the step 112, the glass may have been formed as a sheet (see, e.g., sheet 212 of FIG. 2), such as by fusion draw or float process.

Another step 114 may include cooling the glasses from the heated temperature down to at least a cooled temperature of about 40° C., such as to room temperature or 25° C. During the second step, the rate of cooling may occur at a faster rate while the glass is near the heated temperature (e.g., within 100° C. thereof) than while the glass is near the cooled temperature. Alternatively, the rate of cooling may be controlled to decrease linearly. According to an aspect, the glass is gradually cooled during the step 114 such that the temperature is reduced from the heated temperature to the cooled temperature over at least 2 hours of cooling, such as over at least 4 hours, at least 8 hours, at least 12 hours. Electronics (see, e.g., circuitry 214) may be bonded to the sheet at a step 118, such as after the cooling.

Applicants additionally took the above treatment technology and applied the treatment to lower-loss glasses than those of Tables 1 and 2, where as-analyzed compositions are summarized in the following Table 4 (dielectric properties of AE to AF not yet tested).

TABLE 4

| mol % | G | H | I | J | K | L | M | N | O |
|---|---|---|---|---|---|---|---|---|---|
| SiO₂ | 66.79 | 65.52 | 65.24 | 65.43 | 64.97 | 62.45 | 63.28 | 70.87 | 67.62 |
| Al₂O₃ | 7.59 | 7.54 | 7.56 | 7.56 | 7.55 | 7.51 | 7.44 | 5.91 | 6.78 |
| B2O₃ | 16.03 | 17.53 | 17.76 | 17.57 | 17.42 | 20.71 | 19.93 | 17.31 | 17.63 |
| Li₂O | 0.00 | 0.00 | 0.00 | 0.00 | 0.54 | 0.00 | 0.00 | 0.00 | 0.00 |
| MgO | 5.66 | 5.53 | 4.26 | 3.68 | 3.70 | 5.47 | 5.49 | 3.95 | 4.87 |
| CaO | 3.81 | 3.76 | 3.78 | 3.78 | 3.81 | 3.72 | 3.69 | 1.83 | 2.94 |
| SrO | 0.03 | 0.03 | 0.03 | 0.03 | 0.03 | 0.03 | 0.03 | 0.01 | 0.02 |
| SnO₂ | 0.09 | 0.09 | 0.09 | 0.09 | 0.09 | 0.09 | 0.09 | 0.08 | 0.09 |
| ZnO | 0.00 | 0.00 | 1.28 | 1.85 | 1.88 | 0.00 | 0.00 | 0.00 | 0.00 |
| Cl | 0.00 | 0.00 | 0.00 | 0.00 | 0.00 | 0.01 | 0.04 | 0.03 | 0.04 |
| Dk_{@10GHz} | 4.54 | 4.51 | 4.55 | 4.57 | 4.53 | 4.51 | 4.52 | 4.27 | 4.38 |
| Df_{@10GHz} | 0.0022 | 0.0021 | 0.0021 | 0.0021 | 0.0022 | 0.0020 | 0.0021 | 0.0016 | 0.0018 |
| mol % | P | Q | R | S | T | U | V | W | X |
| SiO₂ | 70.57 | 67.53 | 63.29 | 61.07 | 68.79 | 69.32 | 69.51 | 69.73 | 70.43 |
| Al₂O₃ | 5.91 | 6.76 | 6.63 | 6.39 | 6.26 | 5.32 | 3.74 | 3.44 | 6.01 |
| B2O₃ | 17.46 | 17.65 | 22.25 | 25.00 | 17.58 | 19.09 | 21.83 | 21.59 | 17.50 |
| Li₂O | 0.00 | 0.00 | 0.00 | 0.00 | 0.00 | 0.00 | 0.00 | 0.00 | 0.00 |
| MgO | 3.56 | 3.94 | 3.05 | 2.93 | 2.86 | 2.43 | 1.93 | 1.63 | 3.67 |
| CaO | 1.83 | 2.87 | 4.67 | 4.51 | 4.40 | 3.74 | 2.88 | 2.46 | 1.93 |
| SrO | 0.01 | 0.02 | 0.00 | 0.00 | 0.00 | 0.00 | 0.00 | 1.03 | 0.00 |
| SnO₂ | 0.08 | 0.09 | 0.10 | 0.10 | 0.10 | 0.09 | 0.09 | 0.10 | 0.08 |
| ZnO | 0.54 | 1.10 | 0.00 | 0.00 | 0.00 | 0.00 | 0.00 | 0.00 | 0.38 |
| Cl | 0.04 | 0.05 | 0.01 | 0.01 | 0.01 | 0.01 | 0.01 | 0.01 | 0.00 |
| Dk_{@10GHz} | 4.20 | 4.40 | 4.39 | 4.34 | 4.39 | 4.27 | 4.07 | 4.11 | 4.25 |
| Df_{@10GHz} | 0.0015 | 0.0018 | 0.0019 | 0.0018 | 0.0019 | 0.0016 | 0.0012 | 0.0012 | 0.0017 |
| mol % | Y | Z | AA | AB | AC | AD | AE | AF | AG |
| SiO₂ | 71.45 | 70.48 | 71.48 | 65.34 | 68.18 | 72.28 | 68.75 | 69.84 | 68.57 |
| Al₂O₃ | 6.10 | 5.99 | 6.08 | 7.56 | 6.31 | 5.78 | 5.87 | 2.86 | 3.59 |
| B₂0₃ | 16.29 | 17.47 | 16.29 | 17.49 | 17.77 | 16.14 | 19.35 | 21.92 | 22.61 |
| Li₂O | 0.00 | 0.00 | 0.00 | 0.00 | 0.00 | 0.00 | 0.00 | 0.42 | 0.42 |
| MgO | 3.72 | 4.05 | 4.11 | 4.36 | 5.03 | 3.95 | 3.96 | 2.71 | 1.49 |
| CaO | 1.96 | 1.92 | 1.95 | 3.76 | 2.51 | 1.63 | 1.86 | 2.03 | 3.10 |
| SrO | 0.00 | 0.00 | 0.00 | 0.00 | 0.00 | 0.00 | 0.00 | 0.00 | 0.00 |
| SnO₂ | 0.08 | 0.08 | 0.08 | 0.21 | 0.19 | 0.20 | 0.20 | 0.20 | 0.20 |
| ZnO | 0.39 | 0.00 | 0.00 | 1.27 | 0.00 | 0.00 | 0.00 | 0.00 | 0.00 |
| Cl | 0.00 | 0.00 | 0.00 | 0.01 | 0.01 | 0.01 | 0.01 | 0.00 | 0.00 |
| Dk_{@10GHz} | 4.26 | 4.26 | 4.22 | 4.50 | 4.33 | 4.21 | | | |
| Df_{@10GHz} | 0.0018 | 0.0018 | 0.0016 | 0.0022 | 0.0018 | 0.0015 | | | |

Referring to FIG. 2, glasses disclosed herein may be formed as a sheet 212 and treated, as disclosed above, to improve dielectric performance, and then used as substrates, packaging, support, etc. for electronic devices 210 and other comparable applications, such as to facilitate higher frequency communication in devices without a significant reduction in performance, as it relates to other non-electrical device requirements. Accordingly, glasses of the present disclosure may be suitable for use as substrates in printed circuit boards (PCBs). In some implementations, the glasses are optionally arranged in combination with one or more polymeric substrate layers. Optionally, the glasses may be free of alkali metals to decrease the likelihood of ion migration during processing.

As indicated, the presently disclosed glasses may be utilized in various electronic devices, including as substrates for circuitry 214 (e.g., electrically-conductive elements, printed copper, metal layers, copper patterns,), such as in antennas, semiconductor circuits, signal transmission structures, and PCB. The glass compositions of the present disclosure may be utilized to form various laminated glass structures, designs, and articles.

Construction and arrangements of the compositions, structures, assemblies, and structures, as shown in the various aspects, are illustrative only. Although only a few examples of the aspects have been described in detail in this disclosure, modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. The order or sequence of any process, logical algorithm, or method steps may be varied or re-sequenced according to alternative embodiments. Other substitutions, modifications, changes and omissions may also be made in the design, operating conditions and arrangement of the various aspects without departing from the scope of the present inventive technology.

1. A method of improving dielectric performance of alumino-borosilicate glass, comprising:
heating the glass to a heated temperature of at least 400° C., wherein the heated temperature is less than 1200° C., and wherein, in terms of as-analyzed constituents, the glass comprises:
at least 60 mol % to 75 mol % SiO₂;
at least 2 mol % to 9 mol % Al₂O₃;
at least 15 mol % to 25 mol % B₂O₃;
at least 1 mol % to 6 mol % MgO; and
at least 1 mol % to 5 mol % CaO; and
keeping the glass at the heated temperature for at least 30 minutes; and
cooling the glass from the heated temperature to a cooled temperature of 40° C., over at least 2 hours.

2. The method of claim 1, wherein after the cooling, the glass has a Df no greater than 0.0020.

3. The method of claim 1, wherein the heated temperature is at least 600° C.

4. The method of claim 1, wherein the cooling occurs over at least 4 hours, and wherein the keeping is for at least 2 hours.

5. The method of claim 1, wherein, prior to the heating, the glass has been formed as a sheet.

6. A method of improving dielectric performance of alumino-borosilicate glass, comprising:
forming the glass into a sheet; wherein, in terms of as-analyzed constituents, the glass of the sheet comprises:
at least 60 mol % to 75 mol % SiO₂;
at least 2 mol % to 9 mol % Al₂O₃;
at least 15 mol % to 25 mol % B₂O₃;
at least 1 mol % to 6 mol % MgO; and
at least 1 mol % to 5 mol % CaO; and
keeping the sheet at the heated temperature for at least 30 minutes; and
cooling the sheet from a heated temperature to a cooled temperature of 40° C., over at least 2 hours, and wherein the heated temperature is at least 400° C.

7. The method of claim 6, further comprising bonding electronics to the sheet.

8. The method of claim 7, wherein the bonding is after the cooling.

9. The method of claim 6, wherein after the cooling, the sheet has a Df no greater than 0.0020.

10. The method of claim 6, wherein the heated temperature is at least 600° C.

11. The method of claim 10, wherein the heated temperature is less than 1000° C.

12. The method claim 6, wherein the cooling occurs over at least 4 hours, and wherein the keeping is for at least 2 hours.

13. A method of improving dielectric performance of alumino-borosilicate glass, comprising:
forming a glass into a sheet, wherein, in terms of as-analyzed constituents, the glass comprises:
at least 60 mol % to 75 mol % SiO₂;
at least 2 mol % to 9 mol % Al₂O₃;
at least 15 mol % to 25 mol % B₂O₃;
at least 1 mol % to 6 mol % MgO; and
at least 1 mol % to 5 mol % CaO;
heating the sheet to a heated temperature of at least 400° C., wherein the heated temperature is less than 1200° C.; and
cooling the sheet from the heated temperature to a cooled temperature of 40° C.

14. The method of claim 13, wherein the glass more specifically comprises less than 7.5 mol % Al₂O₃, greater than 16 mol % B₂O₃, and less than 5.5 mol % MgO.

15. The method of claim 13, wherein after the cooling, the sheet has a Df no greater than 0.0020.

16. The method of claim 13, wherein the heated temperature is at least 600° C.

17. The method of claim 13, wherein the cooling occurs over at least 4 hours.

18. A method of improving dielectric performance of alumino-borosilicate glass, comprising:
heating the glass to a heated temperature of at least 400° C., wherein the heated temperature is less than 1200° C., and wherein, in terms of as-analyzed constituents, the glass comprises SiO₂, Al₂O₃, B₂O₃, MgO; and CaO;
keeping the sheet at the heated temperature for at least 30 minutes; and
cooling the glass from the heated temperature to a cooled temperature of 40° C. over at least 2 hours,
wherein after the cooling, the glass has a Df no greater than 0.0020.

19. The method of claim 18, wherein, prior to the heating, the glass has been formed as a sheet.

20. The method of claim 19, further comprising bonding electronics to the sheet after the cooling.
